(19) United States
(12) Patent Application Publication
(10) Pub. No.: US 2017/0099970 A1
(43) Pub. Date: Apr. 13, 2017

(54) Disposable Drip Collar

(71) Applicant: Iwona Szymecka, Largo, FL (US)

(72) Inventor: Iwona Szymecka, Largo, FL (US)

(21) Appl. No.: 14/877,966

(22) Filed: Oct. 8, 2015

(51) Int. Cl. A47G 23/02; B32B 5/18

(52) U.S. Cl. CPC A47G 23/0216; B32B 5/18; B32B 2439/00; B32B 2307/726; B32B 2307/7265

(57) ABSTRACT

The Disposable Drip Collar is a removable drip collar for use with any drinking vessel. The disclosed device includes means for attachment to a drinking vessel, as well as an optional lower seal to prevent drips.

### FIELD

This invention relates to the field of drip collars for drinking vessels and more particularly to a disposable drip collar for use with any drinking vessel.

### BACKGROUND

It is known in the art to use a drip sleeve around a drinking vessel to protect a user's hand from heat.

What is needed is a disposable drip collar that can be used with any drinking vessel, regardless of shape or size.

### SUMMARY

Collars or sleeves are used with drinking cups to protect a user's hand from heat or spillage. The sleeves are often made of paper or other recyclable materials. But such drinking sleeves only fit one size of cup.

The disclosed invention solves the problem of having to make drinking sleeves of various sizes and shapes to fit various drinking vessels by making an adjustable drip collar that can be used with any drinking vessel.

The Disposable Drip Collar is for use with any drinking vessel to prevent spilled liquid or condensation from staining the user's hand or clothing. The Disposable Drip Collar is made of an absorbent material forming a collar that can be threaded through the drinking vessel's handle. The Disposable Drip Collar is held to the drinking vessel by attachment means located on the sides and bottom of the collar.

An additional problem that arises with drinking collars is that over time, or if the spillage is a significant amount, the liquid will reach the bottom of the absorbent collar and drip down to the bottom of the cup or onto clothing. By optionally including a waterproof seal at the bottom of the collar, the Disposable Drip Collar creates a reservoir that prevents any liquid from seeping beyond the bottom of the collar.

The sealing member is waterproof and prevents liquid from leaking out of the collar down the bottom of the drinking vessel.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a first embodiment of the disposable drip collar.

FIG. 2 illustrates a first embodiment of the disposable drip collar applied to a mug.

FIG. 3 illustrates a second embodiment of the disposable drip collar having a sealing member all the way around the bottom.

FIG. 4 illustrates a second embodiment of the disposable drip collar having longer sealing member applied to a mug.

FIG. 5 illustrates a cross-sectional view of the layers of the collar.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

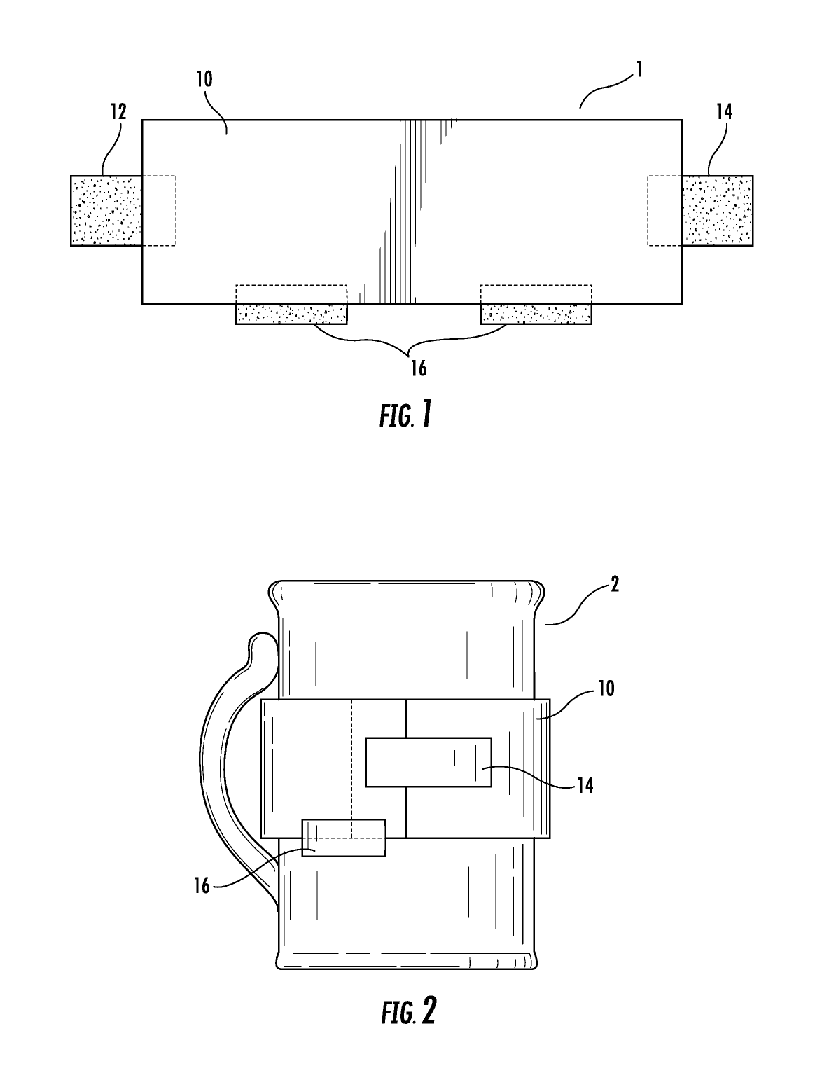

Referring to FIG. 1, the Disposable Drip Collar 1 is shown. The Disposable Drip Collar 1 is comprised of an absorbent collar 10, a first fastener 12, a second fastener 14, and bottom edge fasteners 16.

The collar 10 is made of one or more layers of cardboard, paper towel, or other suitable absorbent material.

The first fastener 12, second fastener 14, and bottom edge fasteners are tape, a snap, hook and loop, or other suitable attachment means.

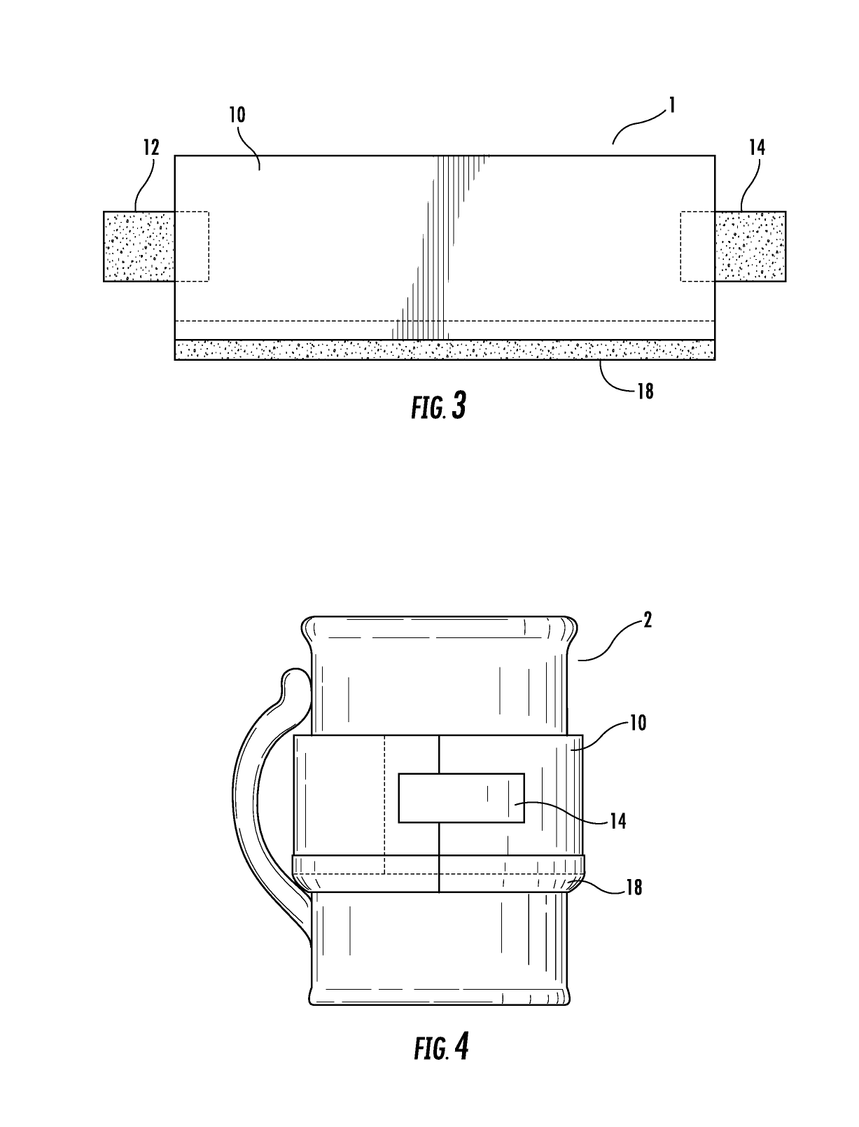

Referring to FIG. 2, the Disposable Drip Collar 1 is shown as applied to a drinking vessel 2. For illustration, the drinking vessel 2 in this figure is a mug. The two fasteners 12 and 14 are attached to the left and right edges of the collar 10.

In order to apply the Disposable Drip Collar 1 to a drinking vessel 2, the user first attaches first fastener 12 to the drinking vessel 2. Next, the collar 10 is wrapped around the drinking vessel 2. Then, the Disposable Drip Collar 1 is secured to the drinking vessel 2 by attaching the second fastener 14 to the collar 10. Finally, the bottom edge fasteners 16 are pressed to the drinking vessel 2 for a more secure fit.

Referring to FIG. 3, a second embodiment of the Disposable Drip Collar is shown. In this embodiment, the collar 10 has a sealing member 16 that runs the full bottom length of the collar 10. The sealing member 16 prevents moisture caused by oversaturation from dripping down onto the user.

The collar 10 is made of one or more layers of cardboard, paper towel, cloth, or other suitable absorbent material. The first fastener 12 and the second fastener 14 are tape, snaps, hook and loop, or other suitable attachment means. The sealing member 16 is made of a material that creates a waterproof seal, such as adhesive tape.

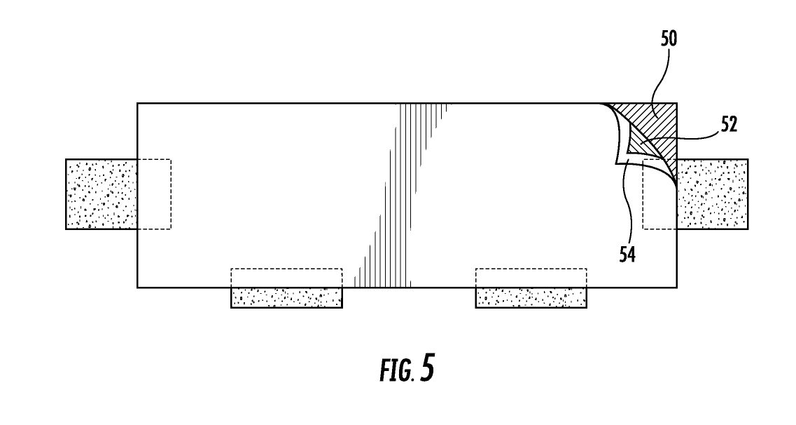

Referring to FIG. 4, the Disposable Drip Collar 1 is shown as applied to a drinking vessel 2. For illustration, the drinking vessel 2 in this figure is a mug. The two fasteners 12 and 14 are attached to the left and right edges of the collar 10.

In order to apply the Disposable Drip Collar 1 to a drinking vessel 2, the user first attaches first fastener 12 to the drinking vessel 2. Next, the collar 10 is wrapped around the drinking vessel 2. Then, the second fastener 14 is attached to the collar 10. Finally, the sealing member 16 is pressed against the drinking vessel 2 to ensure proper sealing along the bottom of the Disposable Drip Collar 1.

Referring to FIG. 5, another embodiment of the Disposable Drip Collar 1 is shown where the collar 10 has a multi-layered construction. In this embodiment, the absorbent collar 10 has three layers: an inner layer 50 that is in contact with the drinking vessel 2, a middle layer 52, and an outer layer 54.

The inner layer 50 is made of a porous material that is absorbent or waterproof. The middle layer 52 is made of paper towel, cardboard, cloth, or other suitably absorbent material. The outer layer 54 is made of a non-absorbent, non-slip material to allow for a better grip. Ideally the inner layer 50 is a wicking material, drawing moisture away from the drinking vessel and channeling it toward the middle layer 52. Additionally, the outer layer 54 is a wicking material, drawing moisture away from the user's hand and channeling it toward the middle layer 52. The result is that the outer layer 54 feels dry to the touch.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A disposable drip collar for use with a drinking vessel, the disposable drip collar comprising:
a. a multi-layered strip of absorbent material having a left edge, a right edge, a top edge, and a bottom edge;
b. a first fastener attached to the left edge for securing the disposable drip collar to the drinking vessel; and
c. a second fastener attached to the right edge for securing the multi-layered strip of absorbent material to itself after wrapping around the drinking vessel; and
d. a sealing member, the sealing member having a top portion, a bottom portion, and an adhesive inner surface,
i. the top portion of the sealing member affixed along the bottom edge via the adhesive inner surface, and
ii. the bottom portion of the sealing member adapted to affix to the drinking vessel via the adhesive inner surface.

2. (canceled)

3. (canceled)

4. The disposable drip collar of claim 1 wherein the sealing member is of a length equal to or greater than the length of the bottom edge.

5. The disposable drip collar of claim 1 wherein the multi-layered strip of absorbent material is non-perforated.

6. The disposable drip collar of claim 1 wherein the multi-layered strip of absorbent material comprises:
a. an outer layer of non-absorbent material;
b. a middle layer of absorbent material;
c. an inner layer of material adapted to prevent sliding against the surface of the drinking vessel, the inner layer having holes so that moisture on the drinking vessel may contact the middle layer of absorbent material.

7. The disposable drip collar of claim 1 wherein the fasteners are selected from the group consisting of: snaps, buttons, and tape.

8. A disposable drip collar for use with a drinking vessel, the disposable drip collar comprising:
a. a strip of absorbent material having a left edge, a right edge, a top edge, and a bottom edge;
b. a first fastener overlapping the left edge for attachment of the strip of absorbent material to the drinking vessel; and
c. a second fastener overlapping the right edge for attachment of the strip of absorbent material to itself after wrapping around the drinking vessel; and
d. a sealing member affixed to the bottom edge and the drinking vessel.

9. (canceled)

10. (canceled)

11. The disposable drip collar of claim 8 wherein the sealing member is of a length equal to or greater than the length of the bottom edge.

12. The disposable drip collar of claim 8 wherein the strip of absorbent material is non-perforated.

13. (canceled)

14. The disposable drip collar of claim 8 wherein the fasteners are snaps.

15. The disposable drip collar of claim 8 wherein the fasteners are buttons.

16. The disposable drip collar of claim 8 wherein the fasteners are tape.

17. A disposable drip collar for use with a drinking vessel, the disposable drip collar comprising:
a. a collar of multi-layered construction with a left edge, a right edge, a top edge, and a bottom edge;
b. the collar of multi-layered construction formed from:
i. an outer layer of non-absorbent material,
ii. a middle layer of absorbent material,
iii. an inner layer of material adapted to prevent sliding against the surface of the drinking vessel, and
iv. the inner layer having openings so that moisture on the drinking vessel may contact the middle layer of absorbent material.

18. (canceled)

19. (canceled)

20. (canceled)

21. The disposable drip collar of claim 1 wherein the sealing member is comprised of two or more sealing members.

22. The disposable drip collar of claim 8 wherein the sealing member affixed to the bottom edge is comprised of a plurality of sealing members, each of the plurality of sealing members for attachment to the drinking vessel.

23. The disposable drip collar of claim 8 whereby the sealing member secures the bottom edge to the drinking vessel.

24. The disposable drip collar of claim 1 wherein the sealing member is of sufficient length to fully surround the drinking vessel.
